(19) United States
(12) Patent Application Publication
(10) Pub. No.: US 2006/0268056 A1
(43) Pub. Date: Nov. 30, 2006

(54) Non-staggered inkjet printhead with true multiple resolution support

(76) Inventors: Josep-Lluis Molinet, Barcelona (ES); Lluis Abello Rosello, Tarragona (ES); Pere Esterri Pedra, Sant Cugat del Valles (ES); David Soriano Fosas, Terrassa (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/140,449

(22) Filed: May 27, 2005

(51) Int. Cl. B41J 29/38; B41J 29/393; B41J 2/145; B41J 2/15

(52) U.S. Cl. 347/40; 347/12

(57) ABSTRACT

An ink delivery system includes a printhead physically rotated to a determined angle relative to an axis orthogonal to a scan axis and includes a plurality of nozzles selectively grouped into at least one virtual primitive. The system further includes a firing circuit configured to sequentially fire the nozzles of each virtual primitive.

### BACKGROUND

Ink jet printers generate an image onto a print medium by ejecting individual drops of ink from one or more printheads onto the print medium through a plurality of nozzles. The printhead is mounted to a carriage that traverses the printhead from one side of the printer to the other. The axis of travel as the printhead traverses the carriage rod is referred to as the scan axis. As the printhead travels back and forth along the carriage rod, ink drops are ejected onto the print medium through the printhead nozzles, which are generally arranged in straight columns on the printhead. However, the relative movement between the printhead, which travels along the scan axis, and the print medium, which is fed through the printer in an orthogonal direction to the scan axis, may cause an undesirable ink drop placement error. In other words, when printing a column of ink drops onto the print medium the relative movement between the printhead and the print medium may cause a column of drops that was otherwise intended to be a straight line to be skewed.

There are two known methods that are commonly used to compensate for the drop placement error that occurs from the inherent movement of the printhead relative to the paper. The first is to physically stagger the nozzles in each column to provide a nozzle offset which will help compensate for the drop placement error. Staggering the nozzles within each column, however, introduces other printing complications such as drop directionality error, drop speed and weight variation, and air bubbles in the ink chamber of the printhead.

The second known method commonly used to compensate for drop placement error caused by the relative movement between the printhead and the print medium is to slant the printhead itself with respect to the scan axis to provide horizontal offset between the nozzles in each column. However, the generally significant degree of slant used to achieve the horizontal offset of the nozzles also introduces an undesirable increased complexity in the mechanical design, and from an image processing standpoint, an increased need for printer memory to compensate for the slant.

Another characteristic of conventional ink jet printers is their limited ability to accommodate multiple resolutions without sacrificing print quality and speed. For example, in either the staggered or the slanted printhead configurations, the columns of nozzles are generally organized into groups that are referred to as primitives. In a staggered or slanted printhead, the size and physical position of these primitives is fixed based upon one or two desirable printing resolutions. Therefore, to print at resolutions other than the optimized resolutions, a printer must operate at an undesirably slower printing speed. If the printing speed is not reduced for these un-optimized resolutions, drop placement error occurs.

The embodiments described hereinafter were developed in light of these and other drawbacks.

### BRIEF DESCRIPTION OF THE DRAWINGS

The present embodiments will now be described, by way of example, with reference to the accompanying drawings, in which:

FIG. 1 is a general illustration of an ink jet printer;

FIG. 2 illustrates an exemplary printhead;

FIG. 2A illustrates an exemplary nozzle plate according to the printhead of FIG. 2.

FIG. 3 is an exemplary control circuit implementing shift registers;

FIG. 4A illustrates an exemplary nozzle configuration showing virtual primitives according to one embodiment;

FIG. 4B illustrates an exemplary nozzle configuration showing virtual primitives according to another embodiment;

FIG. 5 illustrates an exemplary nozzle plate configuration and chart illustrating the relationship between virtual primitives and printing resolution; and

FIG. 6 illustrates the implementation of half-dot correction on an exemplary virtual primitive.

### DETAILED DESCRIPTION

A system and method for printing with true multiple resolutions using a slightly slanted printhead with non-staggered nozzles to reduce drop placement error is provided. The system includes a printhead with a plurality of non-staggered nozzles that are arranged in columns. Horizontal offset between the nozzles in each column to reduce the drop placement error caused by the relative movement between the printhead and the print medium is accomplished by organizing the nozzles into logical or virtual primitives which are programmable and based upon a selected desired printing resolution. In this way, the primitives are virtual rather than physical so that the vertical span of the nozzles is programmable or selectable by a user, according to the desired resolution. In addition, the printhead is physically slanted an incremental amount to assist with reducing drop placement error. The nozzles within each virtual primitive are fired according to a sequential firing scheme, which fires the nozzles of each virtual primitive sequentially from top to bottom, or bottom to top, depending on the direction of the printhead is traveling. In addition, half-dot and quarter-dot correction are fully supported by the virtual primitive configuration and are accomplished using multiplexers to divide the virtual primitive into half and quarter sections, respectively.

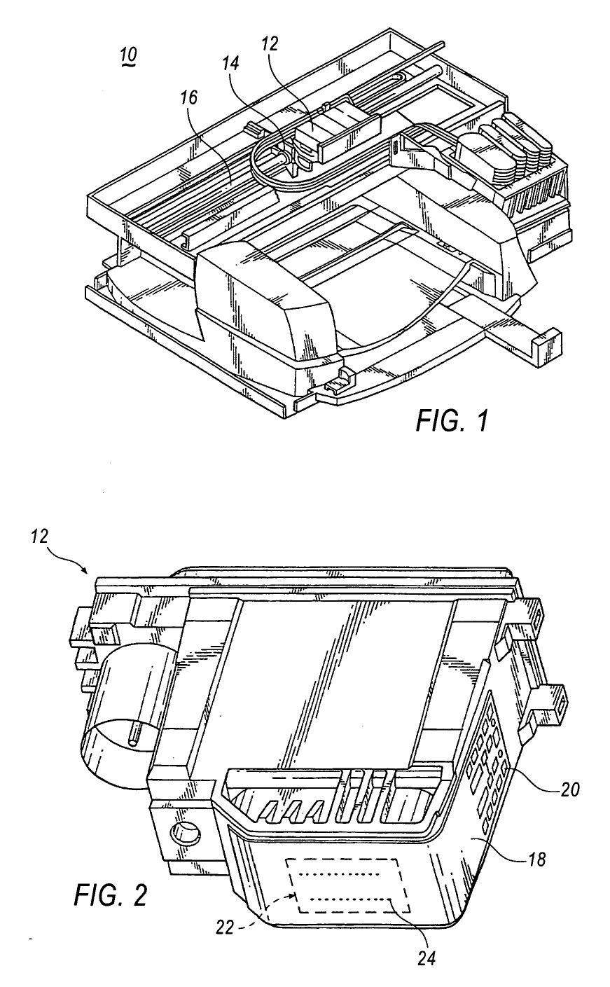

FIG. 1 illustrates a typical ink jet printer 10 having at least one printhead 12 mounted to a scanning carriage 14. The printhead 12 selectively ejects drops of ink onto a printing medium, such as paper (not shown), as the carriage 14 slides along the carriage rod 16 traversing the printhead 12 back and forth from one side of the printer 10 to the other in a bidirectional fashion.

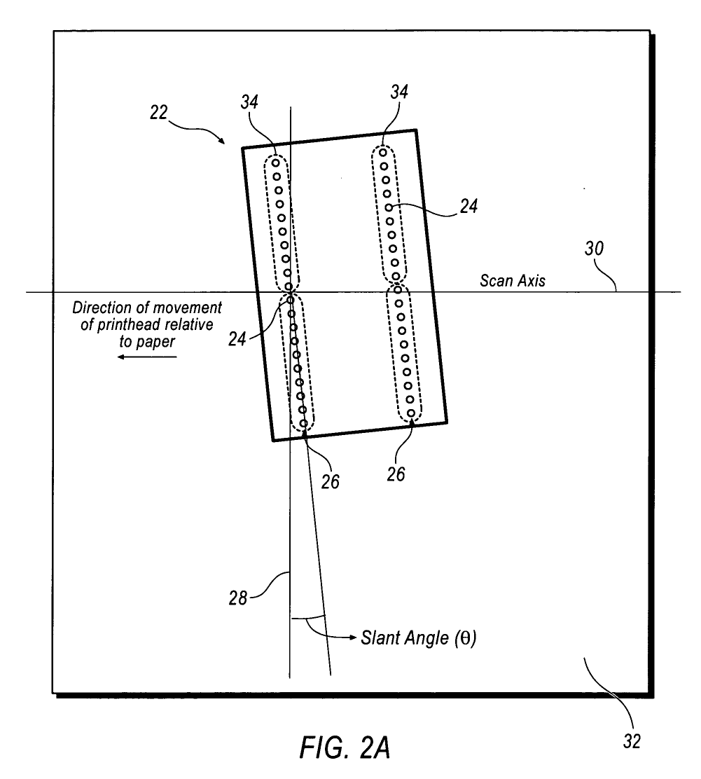

FIG. 2 illustrates an enlarged exemplary printhead 12 having a contact plate 18 with an electrical contact pad 20 and a nozzle plate 22. When secured to the scanning carriage 14, the electrical contact pad 20 connects to electrodes (not shown) on the scanning carriage 14, which communicate with the printer control circuitry (not shown).

An enlarged view of nozzle plate 22 is shown in FIG. 2A having a plurality of non-staggered nozzles 24 arranged in columns 26. The printhead 12 is slanted by a relatively small angle θ (theta) with respect to a vertical axis 28, which is orthogonal to the scan axis 30. The slant provides a horizontal offset between the nozzles 24 in columns 26 to compensate for the relative movement between the printhead 12 and paper 32 during the time it takes for one column 26 of nozzles 24 to fire. The nozzles 24 are further arranged into logical groups of virtual primitives 34. The size of the primitives 34 is programmable or selectable, and as explained in detail below, is dependent on the desired printing resolution of the user.

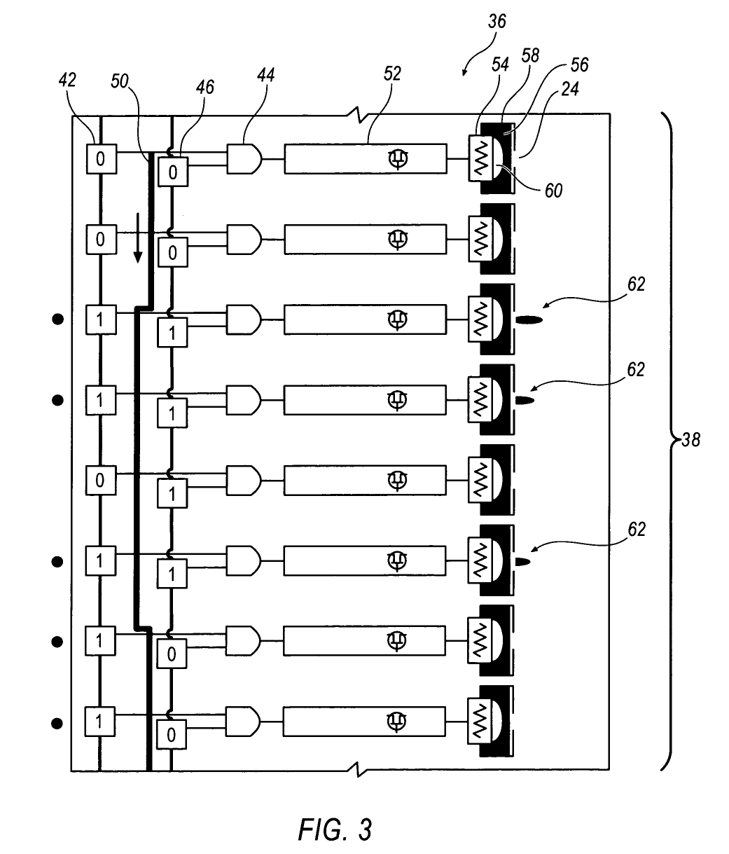

The nozzles 24 in each virtual primitive are activated according to a sequential firing concept using shift registers. FIG. 3 represents a portion of an exemplary firing circuit 36 illustrating shift register firing logic for one virtual primitive 38. For each representative nozzle in the plurality of nozzles 24 there is an associated data load register 42 containing either a “1” or a “0” which corresponds to the presence (“1”) or absence (“0”) of an ink drop command. The data load register 42 is combined by an AND gate 44 with a fire pulse register 46 that contains a “1” or a “0” representing a high (“1”) or a low (“0”) fire pulse value. In other words, as a fire pulse 50 propagates in a sequence through the primitive 38, the value in the fire pulse register 46 changes with respect to the timing of the fire pulse 50.

For example, in FIG. 3 at a particular moment in time, the fire pulse 50 is high “1” for the 3^{rd}, 4^{th}, 5^{th} and 6^{th} nozzles of the primitive 38. The output of the AND gate 44 is configured to energize a power transistor 52, which drives a heat resistor 54. The heat resistor 54 when activated vaporizes ink 56 that is stored in an ink chamber 58 that is fluidically connected to the nozzle 24. The vaporization creates a bubble 60 which forces an ink drop to eject from nozzle 24 onto the print medium (not shown).

In operation, for each nozzle of the primitive 38 the data value in the data load register 42 and the value in the fire pulse register 46 are inputted into the AND gate 44. The result of the AND gate 44 is dependent on the inputted values from the data load register 42 and the fire pulse register 46. For example, in FIG. 3 the data load registers 42 and the fire pulse registers 46 for the first two nozzles in the primitive 38 both contain a “0”. This means that there is no data in the load register 42 that represents an ink drop command and that the fire pulse is low. Therefore, the output of the AND gate 44 is low producing no ink drop. The third nozzle in primitive 38 contains a “1” in the data load register 42 indicating the presence of an ink drop command and the fire pulse register 46 contains a “1” indicating that at this particular moment in time, the fire pulse 50 is high. The output of the AND gate 44 therefore is high, which energizes the power transistor 52 and the heat resistor 54 which initiates the ejection of an ink drop 62. Notice, however, that the fifth nozzle in primitive 38 contains a “1” in the fire pulse register 46 indicating that the fire pulse is high while the value in the data load register is “0” indicating the absence of an ink drop command. The result of the AND gate 44 for the fifth nozzle is therefore low and no ink drop is ejected. For illustrative purposes, the exemplary fire pulse 50 in FIG. 3 shows propagation from the top of the primitive 38 to the bottom of the primitive 38, however, one of ordinary skill in the art understands that the fire pulse 50 can also propagate from bottom of the primitive 38 to top of the primitive 38, indicating that the printhead 12 is printing in the opposite direction.

True multiple resolution is obtained while maintaining ideal operating criteria by slightly slanting the printhead and programming the virtual primitives, according to a desired printing resolution. Ideal operating criteria includes printing across the print medium in one pass at maximum printing speed without drop placement error.

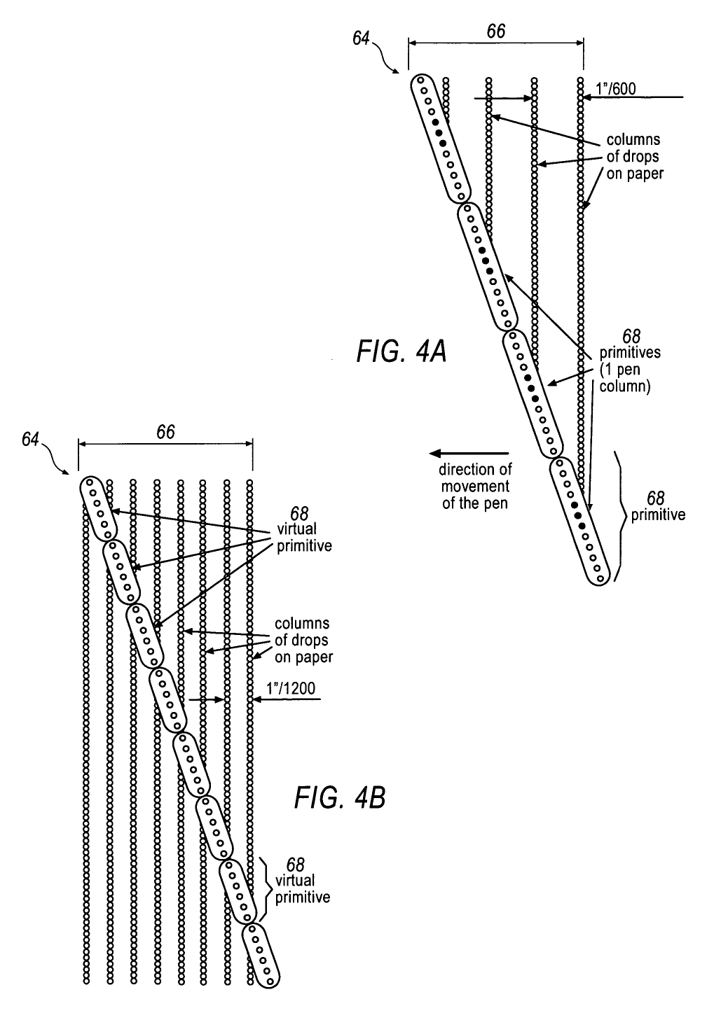

FIGS. 4A-B show exemplary printhead configurations illustrating the relationship between the printhead slant, the desired print resolution, and the selection of virtual primitives. FIGS. 4A and 4B both illustrate a printhead 12 (not shown in FIG. 3) with one column of printhead nozzles 64 having an eight column slant 66. In other words, the column of nozzles 64 is slanted a distance that is approximately equal to the horizontal distance between eight columns of nozzles. As discussed above, this distance is also represented by the angle theta (θ) as previously shown in FIG. 2A and is in general a relatively small angle that is measured from an axis 28, which is orthogonal to scan axis 30. For instance, in a one inch long printhead with a 1200 dpi horizontal resolution, an eight column slant 66 represents less than half of one degree. For purposes of illustration, however, the printhead slant as shown in FIGS. 4A and 4B is exaggerated. Specifically, FIG. 4A illustrates a column of nozzles 64 divided into four primitives 68, according a desired 600 dpi print resolution while the same column of nozzles 64 in FIG. 4B is divided into eight primitives 68 according to a desired 1200 dpi print resolution. The change in the number of virtual primitives from four in FIG. 4A, to eight virtual primitives in FIG. 4B, is accomplished by rerouting the fire pulse 50 (shown in FIG. 3) using multiplexers (not shown).

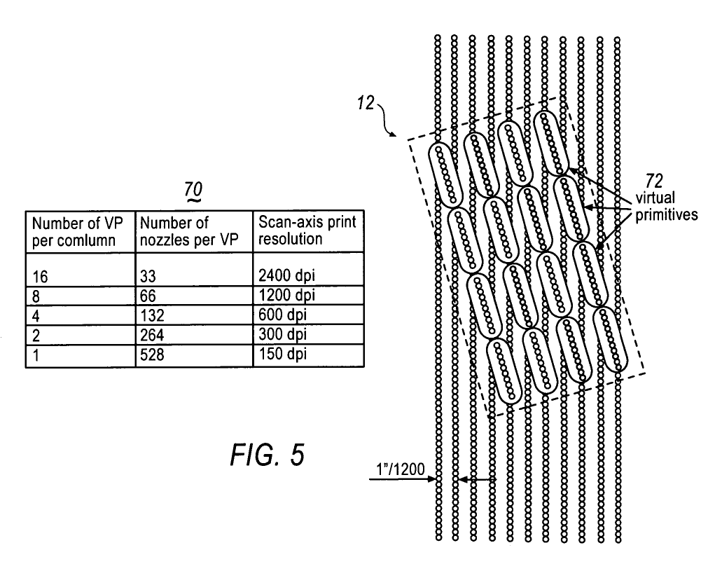

To further illustrate the relationship between virtual primitives and print resolution, FIG. 5 shows an exemplary printhead 12 and a corresponding chart 70 showing the possible arrangements of virtual primitives 72 that support printing resolutions ranging from 150 dpi to 2400 dpi, assuming ideal operating criteria. The exemplary printhead 12 has 2112 nozzles in four columns (528 nozzles each) with a printhead slant of eight columns at 1200 dpi. Any one of the primitive configurations shown in chart 70 can be implemented, however, for illustration purposes, FIG. 5 shows the configuration for a 600 dpi resolution wherein each column has four virtual primitives, each primitive having 132 nozzles.

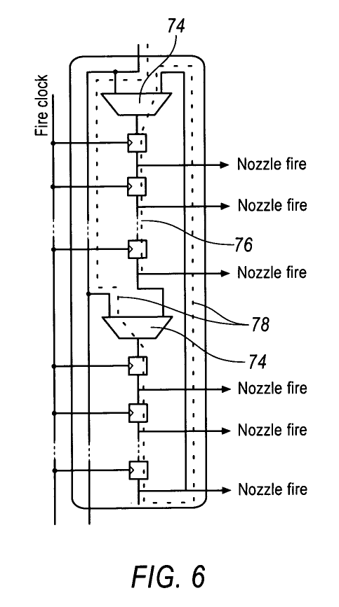

FIG. 6 illustrates the implementation of half-dot correction by splitting the virtual primitive into two parts using multiplexers 74. Instead of starting the fire pulse shift at the top of the virtual primitive, as described above, half-dot correction requires the fire pulse shift 76 to start in the middle of the virtual primitive until the end and then start again with the beginning, following the dotted line 78. In this way, the bottom half of the nozzles in the primitive are shifted half a column to the right and the top half of the nozzles are shifted a half column to the left. Similarly, quarter-dot correction can be applied by using the multiplexers to divide the virtual primitive into 4 parts.

While the present invention has been particularly shown and described with reference to the foregoing preferred embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and system within the scope of these claims and their equivalents be covered thereby. This description of the invention should be understood to include all novel and nonobvious combinations of elements described herein, and claims may be presented in this or a later application to any novel and nonobvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A method for ejecting ink from a printhead, comprising:
slanting a printhead a determined angle relative to an axis orthogonal to a scan axis, said printhead having a plurality of vertically adjacent nozzles;
selectively grouping said vertically adjacent nozzles into at least one virtual primitive; and
firing said nozzles in each of said at least one virtual primitive sequentially from a first end to a second end.

2. The method according to claim 1, wherein the determined angle is based upon a horizontal resolution.

3. The method according to claim 1, wherein selectively grouping said at least one virtual primitive corresponds to a desired printing resolution.

4. The method according to claim 1, further comprising implementing a half-dot correction by dividing said at least one virtual primitive into two parts and sequentially firing the nozzles from a middle portion of said at least one primitive.

5. The method according to claim 1, further comprising implementing a quarter-dot correction by dividing said at least one virtual primitive into four parts.

6. The method according to claim 4 or 5, wherein dividing said at least one primitive into parts is accomplished using multiplexers.

7. The method according to claim 1, wherein said nozzles of said at least one virtual primitive are fired bi-directionally.

8. The method according to claim 1, wherein said nozzles of said at least one primitive are sequentially fired using a shift register logic.

9. The method according to claim 1, wherein the size of said at least one virtual primitive is changed by rerouting a fire pulse using multiplexers.

10. An ink delivery system, comprising:
a printhead physically slanted to a determined angle relative to an axis orthogonal to a scan axis, said printhead includes a plurality of nozzles selectively grouped into at least one virtual primitive; and
a firing circuit configured to sequentially fire said nozzles in said at least one virtual primitive.

11. An ink delivery system according to claim 10, wherein the number of said virtual primitives corresponds to a desired printing resolution.

12. An ink delivery system according to claim 10, wherein said firing circuit implements a half-dot correction by dividing said at least one virtual primitive into two parts and sequentially firing the nozzles from a middle portion of said at least one primitive.

13. An ink delivery system according to claim 10, wherein said firing circuit implements a quarter-dot correction by dividing said at least one virtual primitive into four parts.

14. An ink delivery system according to claim 10, wherein said nozzles of said at least one virtual primitive are fired bi-directionally.

15. An ink delivery system according to claim 10, wherein said nozzles of said at least one primitive are sequentially fired using a shift register logic.

16. An ink delivery system according to claim 10, wherein the size of said at least one virtual primitive is changed by rerouting a fire pulse using multiplexers.

17. A printhead for ejecting ink drops, comprising:
a plurality of nozzles selectively grouped into at least one virtual primitive, said nozzles of at least one virtual primitive are further configured to eject ink drops sequentially from a first end to a second end of said at least one virtual primitive;
wherein said printhead is configured to be mounted to a printer carriage and physically slanted a determined angle with respect to an axis orthogonal to a scan axis.

18. A printhead according to claim 17, wherein the number of said virtual primitives corresponds to a desired printing resolution.
